(19) United States
(12) Patent Application Publication
(10) Pub. No.: US 2006/0033727 A1
(43) Pub. Date: Feb. 16, 2006

(54) Method and apparatus for driving a pixel signal

(76) Inventors: Ying Hao Hsu, Tainan (TW); Hung-Yu Lin, Tainan (TW); Jia-Huang Lee, Tainan (TW); Wang-Yang Li, Tainan (TW); Che-Ming Hsu, Tainan (TW)

Correspondence Address: TROP PRUNER & HU, PC, 8554 KATY FREEWAY, SUITE 100, HOUSTON, TX, 77024, US

(21) Appl. No.: 11/198,141

(22) Filed: Aug. 5, 2005

(30) Foreign Application Priority Data
Aug. 10, 2004 (TW) 093123879

(51) Int. Cl. G09G 5/00

(52) U.S. Cl. 345/204

(57) ABSTRACT

A pixel signal for a pixel has an initial voltage during a frame period. The pixel signal is driven from the initial voltage to an intermediate voltage larger than the initial voltage during the frame period, and the pixel signal is maintained at the intermediate voltage for a time interval. After the time interval, the pixel signal is driven from the intermediate voltage to a target voltage larger than the intermediate voltage during the frame period.

### BACKGROUND

In a liquid crystal display (LCD), applied external voltages or heat cause liquid crystal (LC) molecules to change from a specific initial molecular alignment state to another molecular alignment state, which results in changes of optical properties of the liquid crystal molecules. Changes in optical properties of the liquid crystal molecules include changes in birefringence, polarization, dichromaticism, light scattering, and transmittance. The changes in optical properties change the human eye's perception of the liquid crystal display, such as its brightness.

To drive a liquid crystal display, external voltages are applied to respective pixel electrodes to produce desired rotations of the corresponding liquid crystal molecules. To display dynamic images (images that are continually changing), it is desirable to reduce the response time of the liquid crystal molecules. The response time of a liquid crystal molecule refers to how quickly the liquid crystal molecule responds to an applied external voltage.

Some conventional techniques of reducing response time of the liquid crystal molecules involve over-driving voltages applied to pixel electrodes through data lines, also referred to as source lines or column lines. With many liquid crystal displays, for a given initial voltage v_{g1} of a pixel electrode, the response time will decrease as a target voltage v_{g2} (the voltage the pixel electrode is to be driven to) becomes higher. The response time is derived by the following equation (1):

$$τ on ∝ \frac{γ {d}^{2}}{Δɛ ( {V}_{g2}^{2} - {V}_{g1}^{2} )} \qquad ( Eq . 1 )$$

However, Eq. 1 is not fully applicable to some liquid crystal displays. For example, for liquid crystal displays in patterned vertical alignment (PVA) mode, under certain conditions, when a high voltage is applied, the response time may actually increase with increasing target voltages. Liquid crystal displays in multi-domain vertical alignment (MVA) mode may also behave in similar fashion.

LC molecules in the PVA mode are vertically aligned in the static state, and tilted by an applied electric field across a panel because of their negative dielectric anisotropy. The tilting azimuth of LC molecules is determined by the fringe field effect generated by the patterns of protrusions and slits.

FIG. 16A shows the protrusions and slits layout in the pixel area in a conventional MVA LCD, and FIG. 16B shows the cross-sectional view along line A-A in FIG. 16A. In FIG. 16A, a pixel area 100 defined by an intersection of a scan line 102 and a data line 104 includes a thin-film transistor (TFT) 106 connected to the scan line 102 and the data line 104, and a pixel electrode 108 connected to the TFT 106. As shown in Protrusions 110 and slits 112 are disposed in the pixel area 100 in a color filter substrate 114 and a thin-film transistor substrate 116, respectively. When a protrusion 110 and a slit 112 are so disposed that the angles between the liquid crystal molecules and the upper or the lower polarizers (not shown) are both 45°, the MVA LCD can display a maximum gray scale luminance when light passes through it. Other relative angles of the liquid crystals to the upper and lower polarizers result in abnormal alignment of the liquid crystal molecules.

FIGS. 17A-17E depict simulations of the switching of the liquid crystal molecules in the area 118 in FIG. 16A caused by the fringe field effect generated by the patterns of the protrusions and the slits in response to transitions from zero volt to applied external voltages. The transverse axes and vertical axes in FIGS. 17A-17E correspond to the A-A′ and A-B directions in FIG. 16A, respectively. As shown in the example of FIGS. 17A and 17B, when the external voltage is 5V and 5.5V, respectively, the liquid crystal molecules in the area 118 are aligned by the fringe field effect and so appear to be normally switched. However, as shown in FIGS. 17C-17E, when the external voltage is increased to 5.75V, 6.0V, and 6.5V, respectively, some liquid crystal molecules in regions 120a and 120b are not aligned by the fringe field effect and so appear abnormally switched. The abnormal switching of liquid crystals is most pronounced in regions 120a, 120b of FIG. 17E.

Some time after occurrence of abnormal switching of liquid crystal molecules, the abnormally switched liquid crystals may be re-tilted by the effect of the adjacent liquid crystal molecules to the correct angle. However, having to wait for re-tilting of the abnormally switched liquid crystals increases the response time of the corresponding pixel. If the abnormally switched liquid crystal molecules are not re-tilted to the correct angle, then anomalies, such as gray or black spots, may appear in the liquid crystal display.

### BRIEF DESCRIPTION OF THE DRAWINGS

FIG. 1 is a block diagram of a display module and a data compensation device, according to an embodiment.

FIG. 2A is a graph of a driving voltage of a pixel as a function of time according to a conventional driving technique.

FIG. 2B is a graph of a brightness of the pixel as a function of time in response to the driving voltage of FIG. 2A.

FIG. 3A is a graph of a driving voltage of a pixel as a function of time according to a conventional driving technique.

FIG. 3B is a graph of a brightness of the pixel as a function of time in response to the driving voltage of FIG. 3A.

FIG. 4A is a graph of a driving voltage of a pixel as a function of time according to a multi-step driving technique according to an embodiment.

FIG. 4B is a graph of a brightness of the pixel as a function of time in response to the driving voltage of FIG. 4A.

FIG. 5 is a graph that correlates response times to gray scale levels for a conventional driving technique and a multi-step driving technique.

FIG. 6 is a graph that correlates voltage levels to gray scale levels.

FIG. 7 is a graph that compares response times of a pixel when driven according to a conventional driving technique and a multi-step driving technique according to an embodiment.

FIG. 8 is a graph of a driving voltage for a pixel as a function of time according to an over-driving technique according to an embodiment.

FIG. 9 is a graph of a driving voltage for a pixel as a function of time according to a combined driving technique that combines the multi-step driving technique and the over-driving technique according to an embodiment.

FIG. 10 is a flow diagram of a process of applying the multi-step driving technique and over-driving technique, according to an embodiment.

FIG. 11 is a graph that compares response times of a pixel in response to a conventional driving technique, an over-driving technique, a multi-step driving technique, and a combined technique that combines the over-driving technique and multi-step driving technique.

FIG. 12 is a block diagram of a data compensation device according to an embodiment.

FIG. 13 is a block diagram of an integrated data compensation device and display driving device according to an embodiment.

FIG. 14 is a block diagram of a display system circuit board that contains the data compensation device according to an embodiment.

FIG. 15 is a block diagram of the data compensation device implemented by a system device according to another embodiment.

FIG. 16A illustrates the protrusions and slits layout in the pixel area in a conventional MVA LCD.

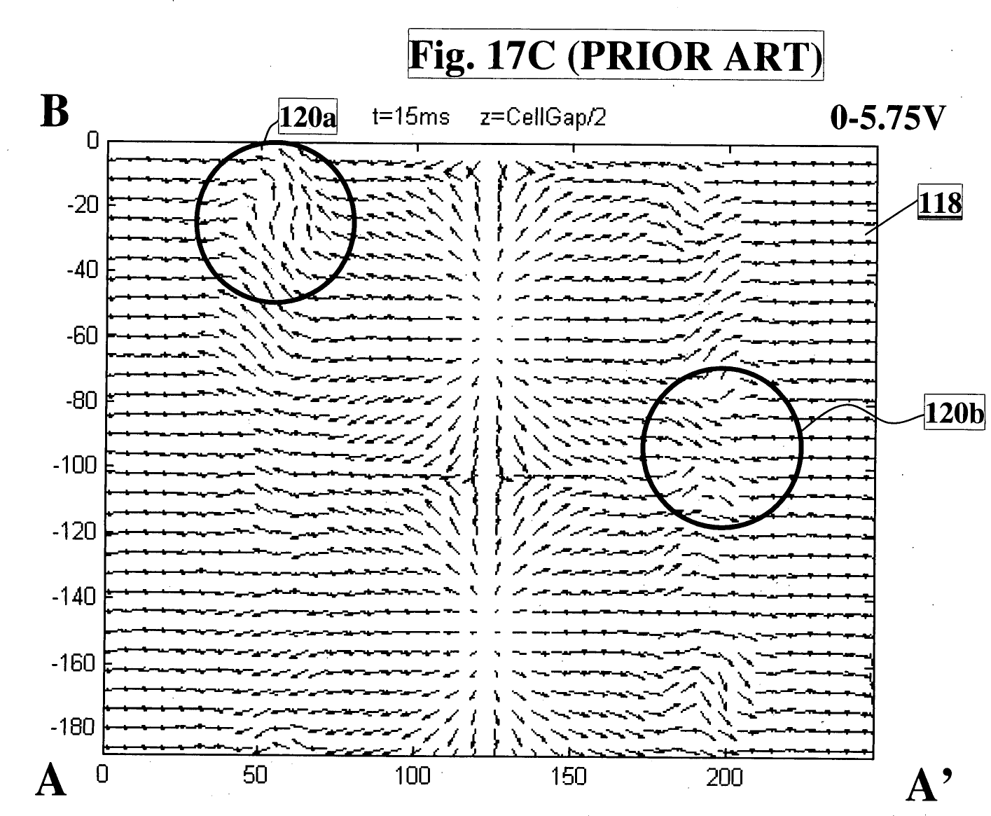

FIG. 16B illustrates the cross-sectional view along the A-A line of FIG. 16A.

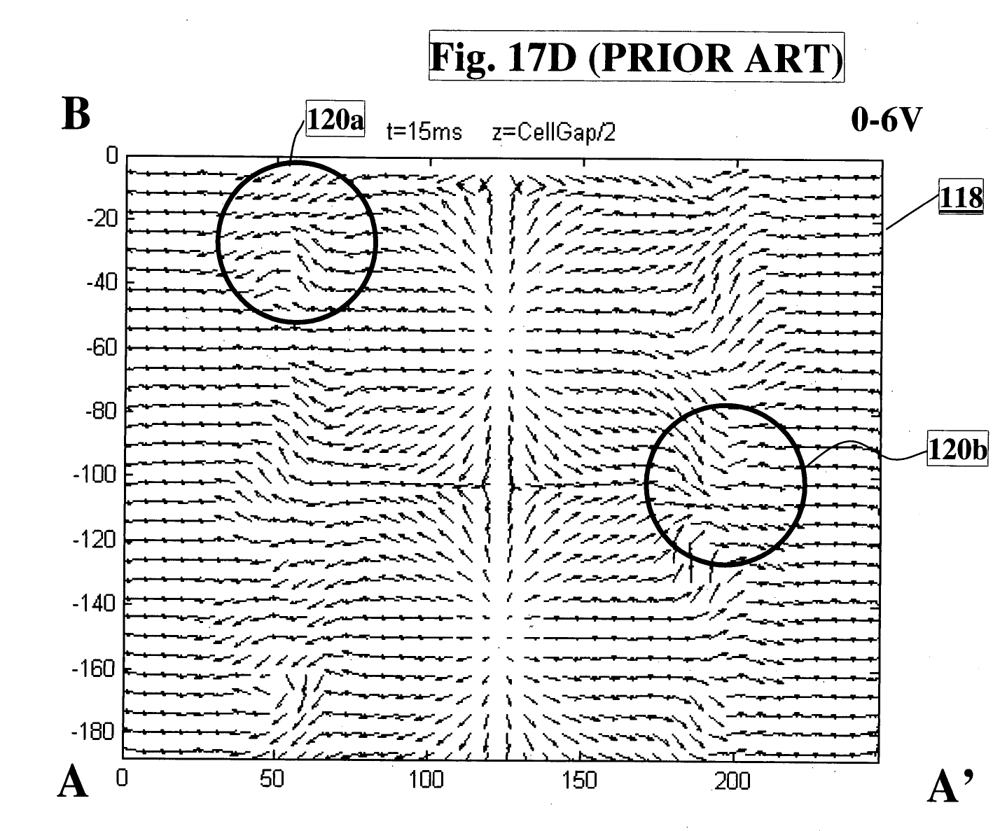

FIGS. 17A-17E illustrate simulation results of the switching of the liquid crystal molecules over an area of FIG. 16A caused by the fringe field effect generated by the patterns of the protrusions and the slits.

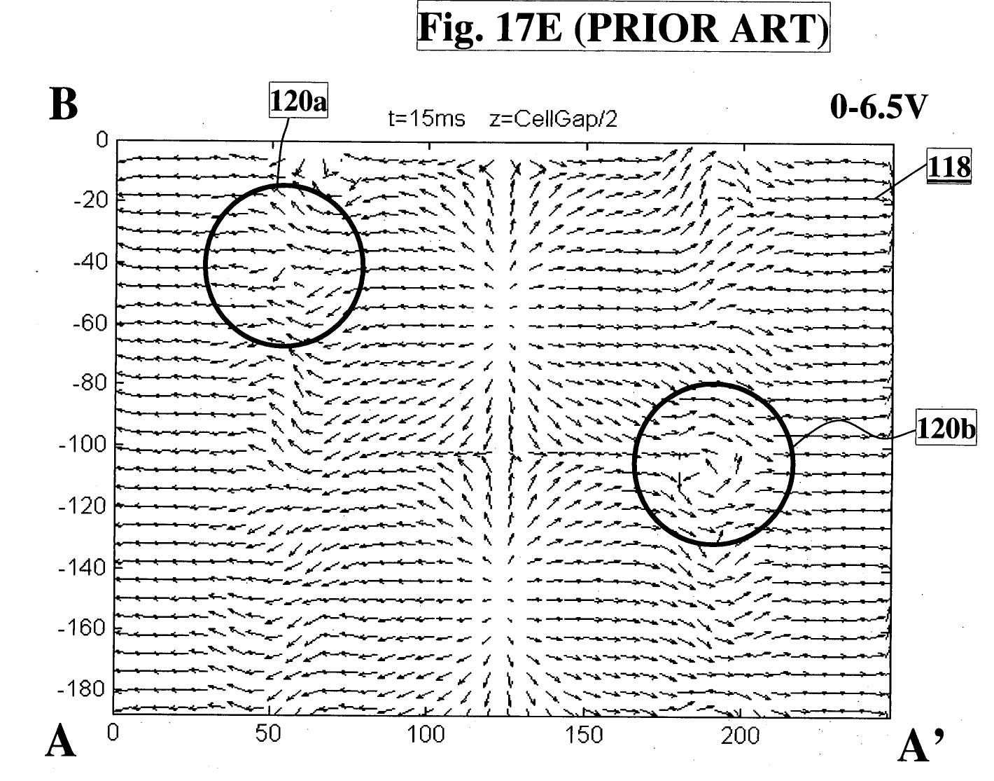

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

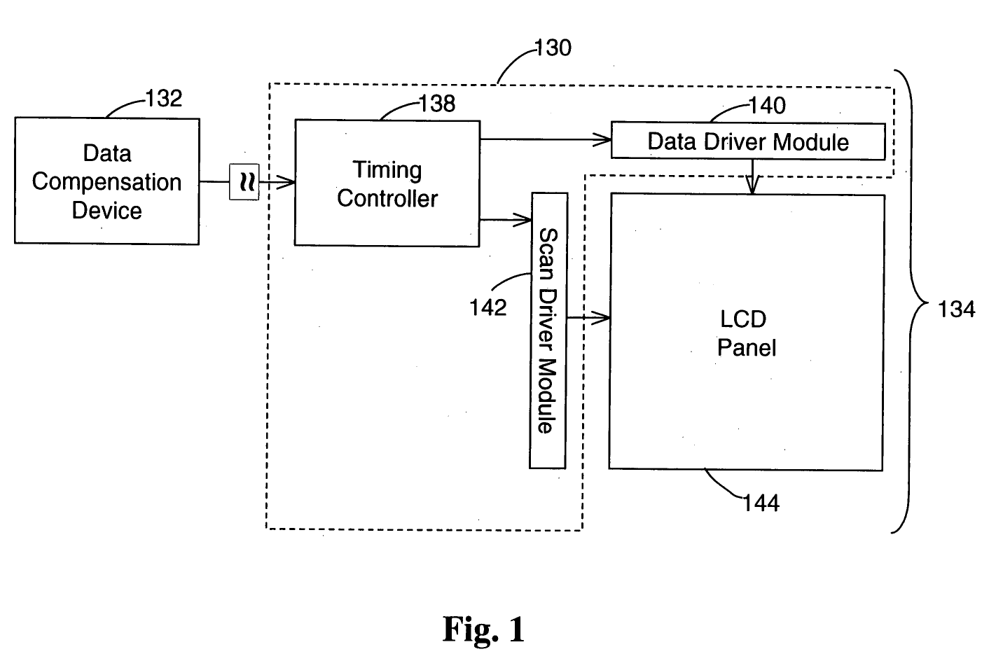

FIG. 1 illustrates a display module 134 that includes a display driving device 130 for driving a liquid crystal display (LCD) panel 144. The display driving device 130 includes a data driver module 140 for driving data lines (also referred to as source lines or column lines) of the LCD panel 144. The display driving device 130 also includes a scanner driver module 142 for driving scan lines (also referred to as row lines) of the LCD panel 144.

The LCD panel 144 can be a vertical alignment (VA) type LCD panel, a patterned vertical alignment (PVA) type LCD panel, a multi-domain vertical alignment (MVA) type LCD panel, or other type of LCD panel.

A timing controller 138 in the display driving device 130 receives image data, and in response to the image data, supplies signals corresponding to the image data to the data driver module 140. The data driver module 140 in turn drives signals on data lines to appropriate voltage levels according to the signals corresponding to the image data. The timing of drivers in the data driver module 140 and scan driver module 140 are controlled by the timing controller 138.

In accordance with some embodiments of the invention, the image data received by the display driving device 130 includes compensation image data generated by a data compensation device 132. The compensation image data received by the display driving device 130 allows for the application of stepped voltage levels (multi-step voltage application or multi-step driving technique) within a frame period to selected ones of pixels in the LCD panel 144 under certain conditions. Also, the compensation image data provided by the data compensation device 132 allows for over-driving of voltages on data lines for selected pixels under certain conditions. As discussed in greater detail below, the multi-step driving technique and over-driving technique for driving voltages on data lines for selected pixels improve response times of liquid crystal molecules.

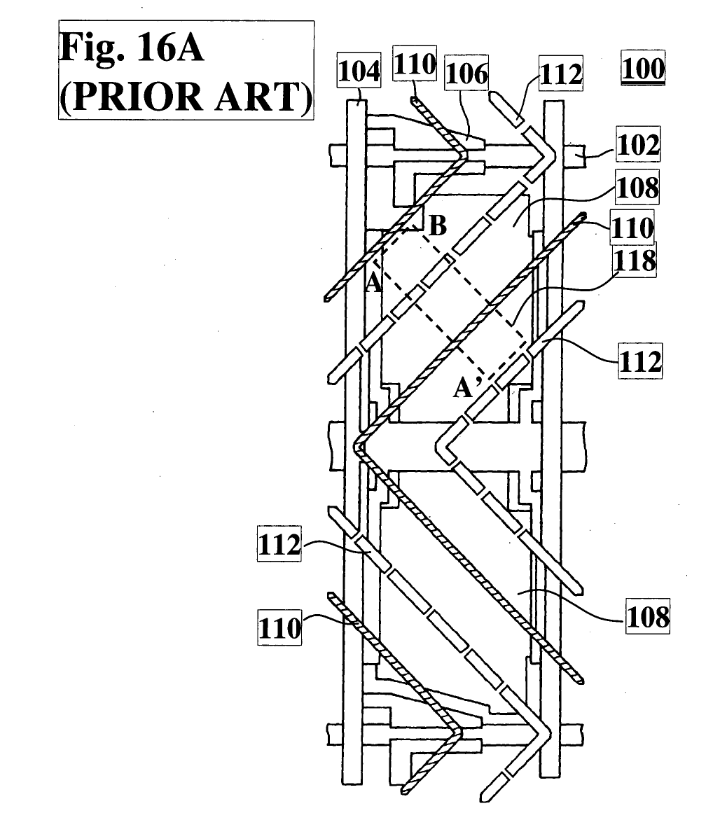

The data compensation device 132 can be implemented in any of various parts of a system, discussed further below in connection with FIGS. 12-15.

A voltage provided on a data line by the data driver module 140 is communicated through a thin-film transistor (TFT) of the LCD panel for a selected pixel. The TFT is turned on by activating a scan line by the scan driver module 142. The voltage applied on the data line, when communicated through the TFT to a pixel, causes rotation of corresponding liquid crystal molecules.

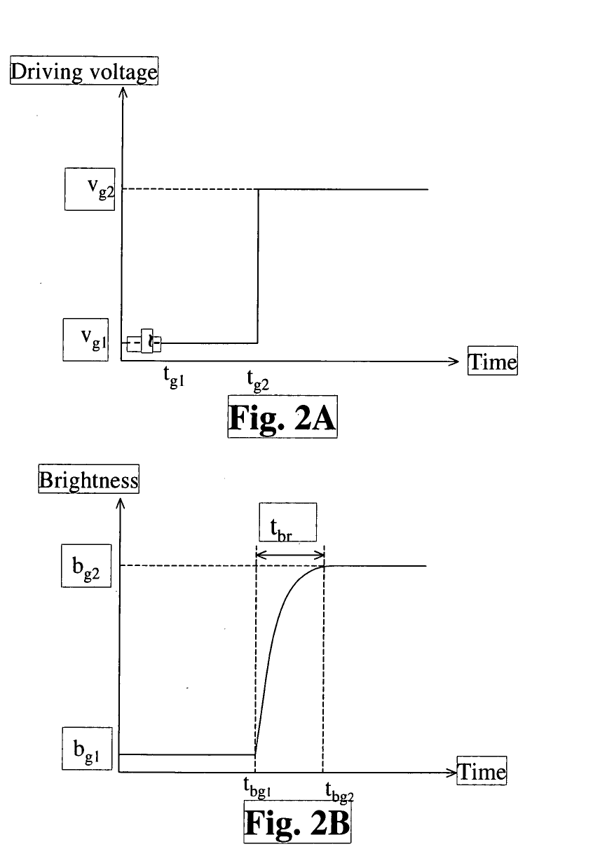

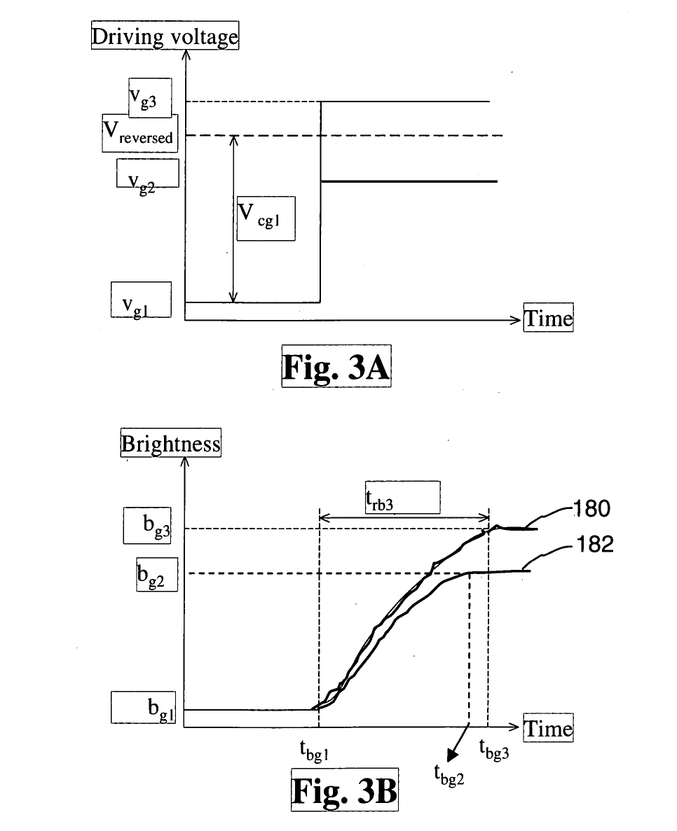

An initial voltage, or initial gray scale voltage, of a pixel signal supplied over a data line to a selected pixel is a reference voltage potential across the selected pixel. A target voltage, or target gray scale voltage, is a voltage to achieve a target luminance by rotating corresponding liquid crystal molecules. As shown in the example of FIG. 2A, a gray scale voltage of a pixel changes from an initial gray scale voltage v_{g1} to a target gray scale voltage v_{g2} to rotate the liquid crystal molecules of the pixel. FIG. 2B shows the change in pixel luminance (corresponding to a brightness perceived by a user) with respect to time. The liquid crystal molecules change from an initial alignment state to a different alignment state during a response time t_{br} (period between t_{bg1} and t_{bg2}) In other words, the pixel luminance changes from an initial luminance b_{g1} to a target luminance b_{g2} during a response time t_{br} to display a target gray scale level.

As discussed above, when the liquid crystal molecules change from a vertical alignment state to a horizontal alignment state, if the instant variation of the applied voltage across the pixel is too large, the liquid crystal molecules may rotate in wrong directions to result in abnormal switching. According to optical-electronic characteristics of liquid crystal molecules, a pixel has a reversed bias voltage v_{cg1} corresponding to an initial voltage v_{g1}. When an instant variation (a bias voltage) of a driving voltage is larger than the reversed bias voltage v_{cg1}, liquid crystal molecules of the pixel may switch abnormally.

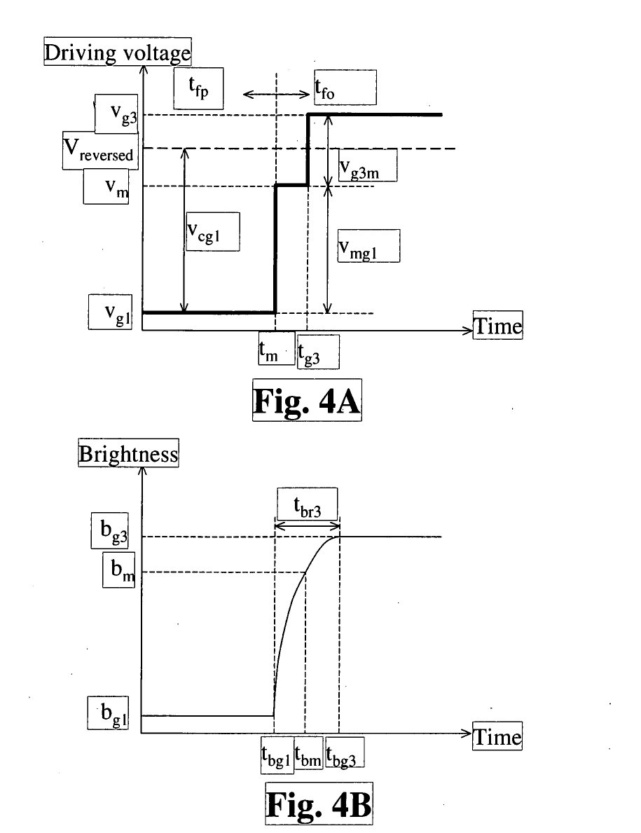

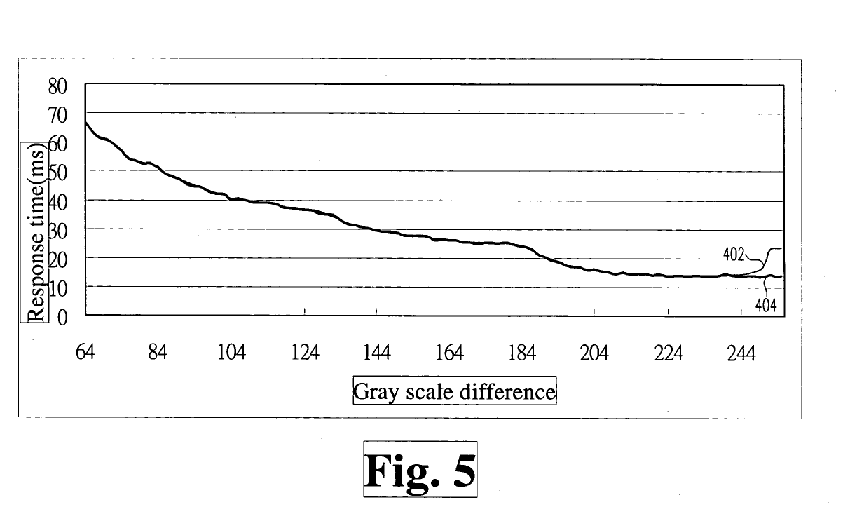

The abnormal switching effect is illustrated in FIGS. 3A-3B. As shown in FIG. 3A, a target voltage v_{g3} of the pixel is larger than a reversed voltage V_{reversed}, where the reversed voltage V_{reversed} is a voltage of the initial v_{g1} voltage plus the reversed bias voltage v_{cg1} of the pixel. Different initial voltages result in respective different reversed voltages. A “reversed bias voltage” refers to voltage step that may cause abnormal switching of liquid crystal molecules. Different LCD panels may have different reversed bias voltages. Also, different initial voltages are associated with different reversed bias voltages. If a driving voltage is raised from the initial voltage v_{g1} to the target voltage v_{g3} directly, the voltage difference between the initial voltage v_{g1} and the target voltage v_{g3} being larger than the reversed bias voltage v_{cg1} may cause the liquid crystal molecules of the pixel to rotate in wrong directions to cause abnormal switching. As a result, as shown in FIG. 3B, the pixel luminance (represented by curve 180) needs a longer response time t_{rb3} to change from the initial luminance b_{g1} to the target luminance b_{g2}. Because abnormal switching of the liquid crystal molecules results in longer response time of the pixel, image retention may appear in the display screen.

Curve 182 in FIG. 3B illustrates the change in pixel luminance when the driving voltage is driven from v_{g1} to v_{g2}, where the difference between v_{g1} and v_{g2} is less than the reversed biased voltage v_{cg1}. In this scenario, the pixel luminance changes from the initial luminance b_{g1} to the target luminance b_{g2} in response time (t_{bg1}-t_{bg2}), which is less than t_{rb3}. Therefore, FIG. 3B illustrates the effect of increased response time when the driving voltage step exceeds the reversed biased voltage of a pixel.

To address the issue of abnormal switching of liquid crystal molecules resulting from a voltage step that exceeds the reversed bias voltage of the pixel, multi-step voltage application is employed according to some embodiments. The multi-step application of voltages to a pixel involves provision of a pixel signal (on a data line) to the pixel selected by a scan line, where the pixel signal is driven from an initial voltage to an intermediate voltage (larger than the initial voltage), then after a time interval, from the intermediate voltage to a target voltage (larger than the intermediate voltage).

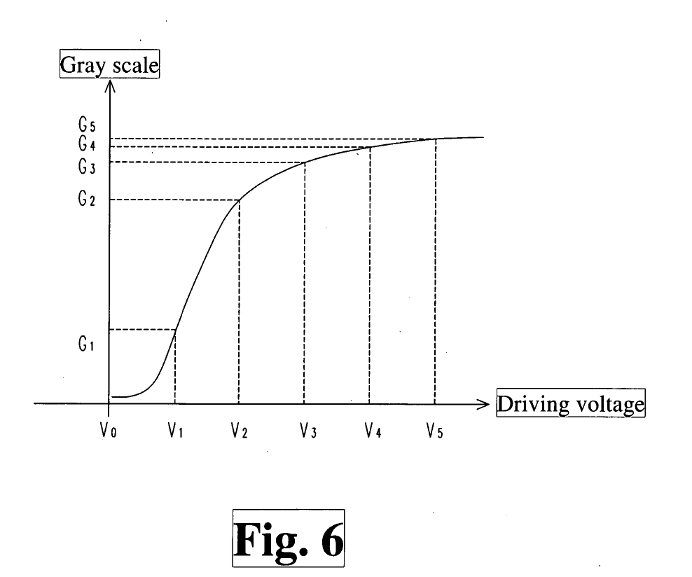

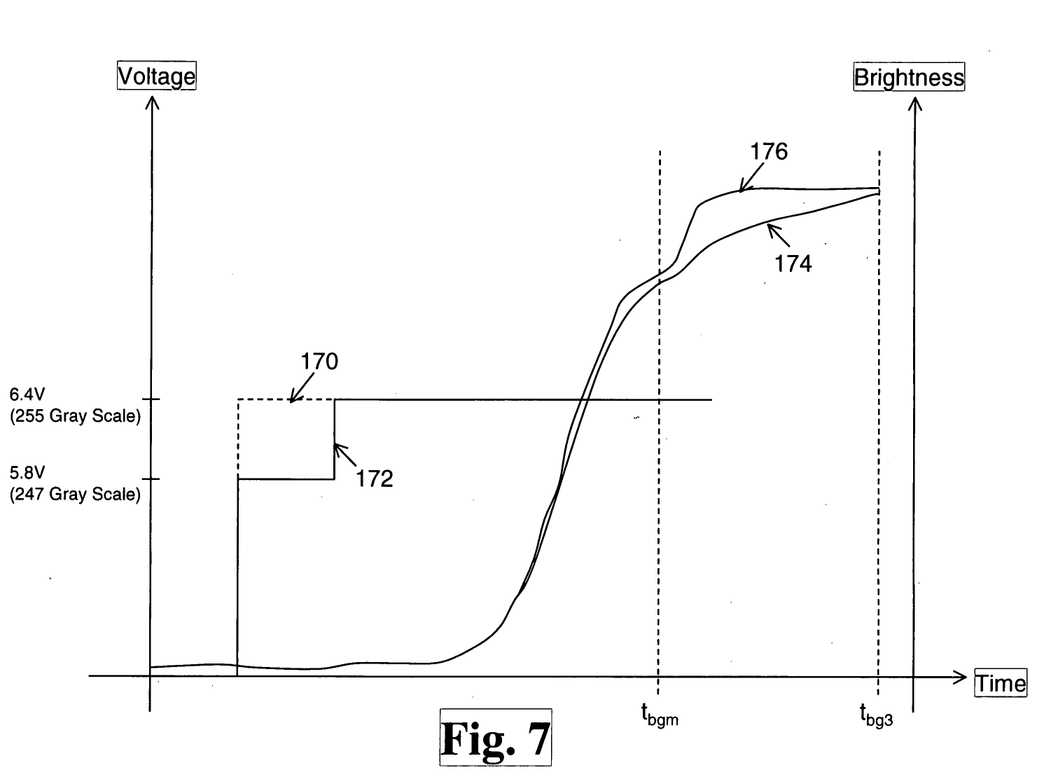

As shown in FIG. 4A, the pixel has an initial voltage v_{g1} during a current frame period t_{fo}. The initial voltage v_{g1} may be the target voltage for the pixel in a previous frame period t_{fp}. The multi-step driving technique according to some embodiments of the invention supplies bias voltages in plural steps from the initial voltage v_{g1} to the target voltage v_{g3} to avoid a voltage step greater than the reversed bias voltage v_{cg1}. As depicted in FIG. 4A, this means that a voltage step from the initial voltage v_{g1} to a voltage greater than the reversed voltage V_{reversed} is avoided. At a time tₘ, which is at or near the beginning of the current frame period t_{fo}, a first bias voltage v_{mg1} is supplied. Application of the first bias voltage v_{mg1} causes a voltage step from the initial voltage to the higher intermediate voltage vₘ, where v_{mg1}<v_{cg1}. Then, at a time t_{g3}, which occurs a time interval after tₘ, a second bias voltage v_{g3m} is supplied, which causes the driving voltage to increase from the intermediate voltage vₘ to the higher target voltage v_{g3}. The intermediate voltage supplied to the pixel is maintained constant at the intermediate voltage vₘ for a time interval between tₘ and t_{g3}.

Note that the time interval t_{g3}-tₘ of the multi-step driving technique (time interval during which the applied voltage steps from the initial voltage to the intermediate voltage than to the target voltage) may in some embodiments be less than the current frame period (t_{fo}). A “frame” represents a complete image from a series of images. A “frame period” contains an active period and a blanking period, where the active period is the time period to drive all pixels of an LCD panel, and the blanking period is used to match the period for blanking performed in CRT (cathode ray tube) monitors.

As noted above, different initial voltages correspond to different reversed bias voltages. Thus, after the voltage has been driven to the intermediate voltage vₘ, it should be noted that the intermediate voltage itself is associated with its respective reversed bias voltage v_{cm} (not shown). Therefore, the second bias voltage v_{g3m} applied at time t_{g3} should be smaller than this reversed bias voltage v_{cm}. The issue of abnormal switching of liquid crystal molecules and slower response time of the pixel are usually more pronounced at lower initial voltages, so it is usually more productive to reduce the magnitude of the first bias voltage v_{mg1} than the subsequent applied bias voltage after elevation of the applied voltage to the intermediate voltage.

FIG. 4B is a diagram showing changes of pixel luminance in relation to time in response to the voltages applied in FIG. 4A. In response to the voltage being raised to the intermediate voltage vₘ that is less than the bias voltage in the interval between time tₘ and the time t_{g3}, the luminance of the pixel is raised from an initial luminance b_{g1} to an intermediate luminance bₘ. In response to the subsequent raising of voltage from vₘ to v_{g3}, the luminance is raised continuously to a target luminance b_{g3}. Because the first bias voltage v_{mg1} supplied by the multi-step driving technique is less than the reversed bias voltage v_{cg1}, the liquid crystal molecules within the pixel can rotate normally (in other words, the liquid crystal molecules are not caused to rotate in the wrong directions), and the luminance of the pixel can be raised to the predetermined target luminance b_{g3} with improved response time.

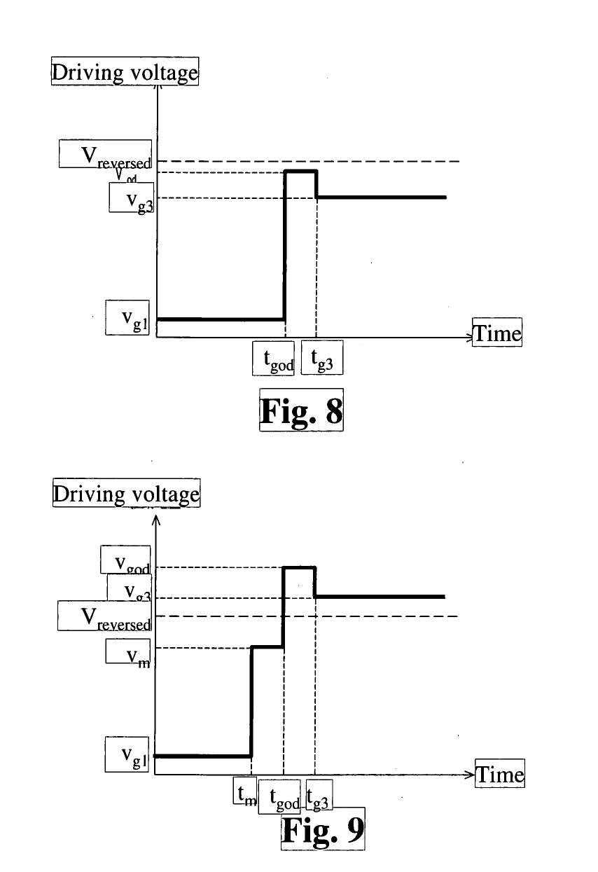

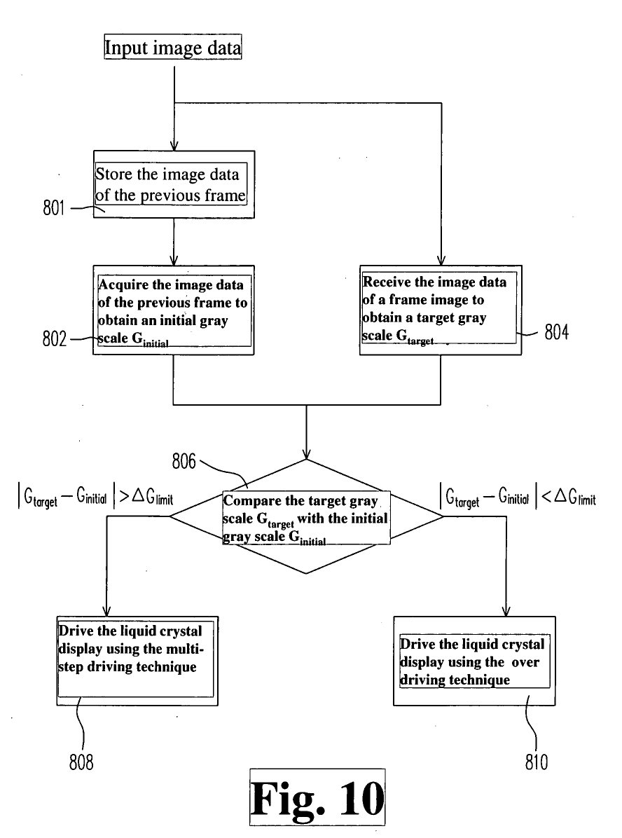

FIG. 5 shows the correlations between gray scale difference values (abscissa) (gray scale difference is the difference between zero gray scale and the target gray scale) and corresponding response times (ordinate) in a liquid crystal display in vertical alignment mode using the multi-step driving technique and the conventional driving technique. FIG. 6 illustrates the correlation between the gray scale and the driving voltage of the liquid crystal display. In regions of low gray scale variation (difference between initial voltage and target voltage is relatively small), response time is negatively correlated with gray scales; in other words, when the gray scale difference is higher, the driving voltage is higher (as shown in FIG. 6), and the response time of the liquid crystal display is shorter. However, when the gray scale difference is over a predetermined threshold, e.g., initial zero gray scale to target 244 gray scale as shown in FIG. 5, the liquid crystal molecules using a conventional driving technique will exhibit abnormal switching, which causes the response time to be longer as the gray scale difference increases (curve 402) over the 244 gray scale level. In contrast, when using the multi-step driving technique according to an embodiment, as the gray scale difference continues to increase, the response time will continue to be shorter (curve 404), thereby maintaining the quality (in terms of response time) of the liquid crystal display.

Although the description refers to a vertical alignment liquid crystal display as an example, techniques according to some embodiments can be applied to another type of liquid crystal display, e.g., twisted nematic (TN) displays. In TN displays, liquid crystal molecules may also rotate in wrong directions in response to the instant discharge bias voltage being larger than the reversed bias voltage of a pixel.

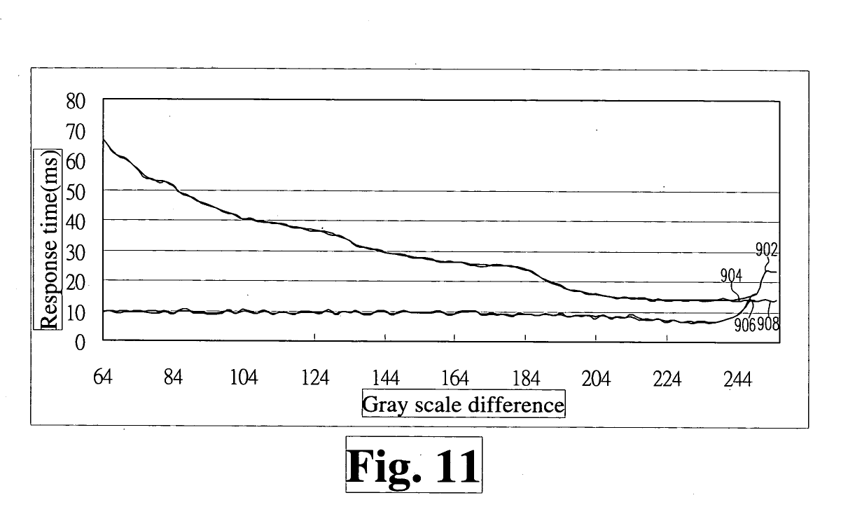

FIG. 7 shows correlation between the corresponding brightness from 0 to 255 gray scale and the response time, and between the applied voltage and the response time, according to a conventional driving technique and the multi-step driving technique. Curve 170 of FIG. 7 illustrates the conventional voltage driving technique in which the applied bias voltage is stepped from zero to 6.4 volts. Note that this step from zero to 6.4 volts exceeds the reversed bias voltage of the pixel, which causes abnormal switching of liquid crystal molecules. Consequently, as depicted by curve 174, the response time of the pixel to increase from the zero gray scale to the 255 gray scale is time interval t_{bg3}. Response time can be improved by driving the target voltage to 5.8 volts (to correspond to 255 gray scale)—however, the brightness that can be achieved is lower than the brightness at 6.4 volts.

In contrast, with the multi-step driving technique according to an embodiment, the applied bias voltage is first driven (see curve 172) to an intermediate voltage (5.8 volts in the example of FIG. 7, which corresponds to the 247 gray scale). After maintaining the applied voltage at the intermediate voltage, the applied voltage is increased to the target voltage of 6.4 volts, which corresponds to the 255 gray scale (see curve 172). As depicted by a curve 176, when the brightness of the pixel firstly increases from zero to 247 gray scale and then to the target 255 gray scale, the response time for the pixel to reach the target gray scale is time interval t_{bgm}, which is much smaller than t_{bg3} (the response time associated with the conventional driving technique). Moreover, the desired brightness of the 255 gray scale can be achieved by driving the voltage to 6.4 volts.

According to some embodiments, the multi-step driving technique discussed above can be optionally combined with an over-driving technique. When the gray scale difference (difference between initial gray scale and target gray scale) for a selected pixel is relatively small, the over-driving technique can be used to drive the selected pixel. However, when the gray scale difference is larger than the reversed bias voltage, the multi-step driving technique can be used to drive the selected pixel. Furthermore, the display driving device 130 (FIG. 1) can selectively switch between the two techniques according to different situations.

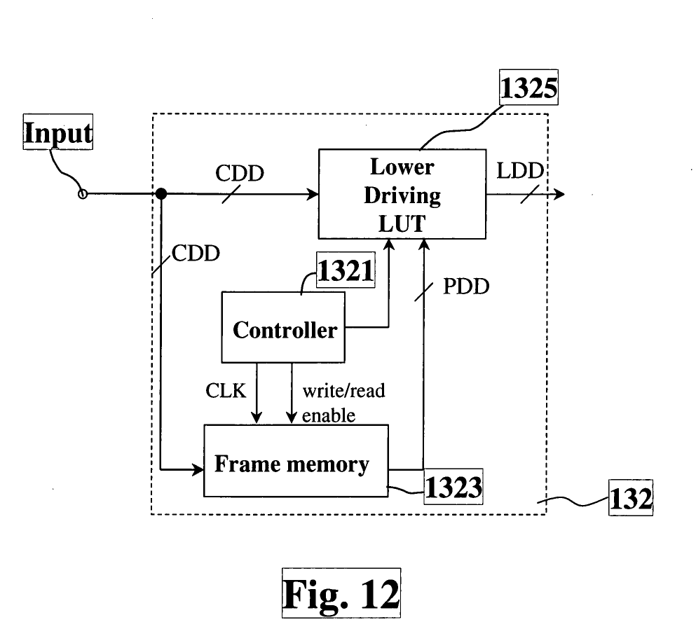

FIG. 8 is a graph depicting driving voltages as a function of time for the over-driving technique according to an implementation. As shown in FIG. 8, a target voltage v_{g3} of a pixel is smaller than a reversed voltage V_{reversed}. At a time t_{god}, the driving voltage is increased to an over-driving voltage V_{od}, which is between the target voltage V_{g3} and the reversed voltage V_{reversed}. As a result, liquid crystal molecules of the pixel will rotate to an angle corresponding to the target voltage V_{g3} in a shorter time. After the liquid crystal molecules rotate to the corresponding angle at a time t_{g3}, the driving voltage is changed to the target voltage v_{g3} to keep a state of normal switching of the liquid crystal molecules.

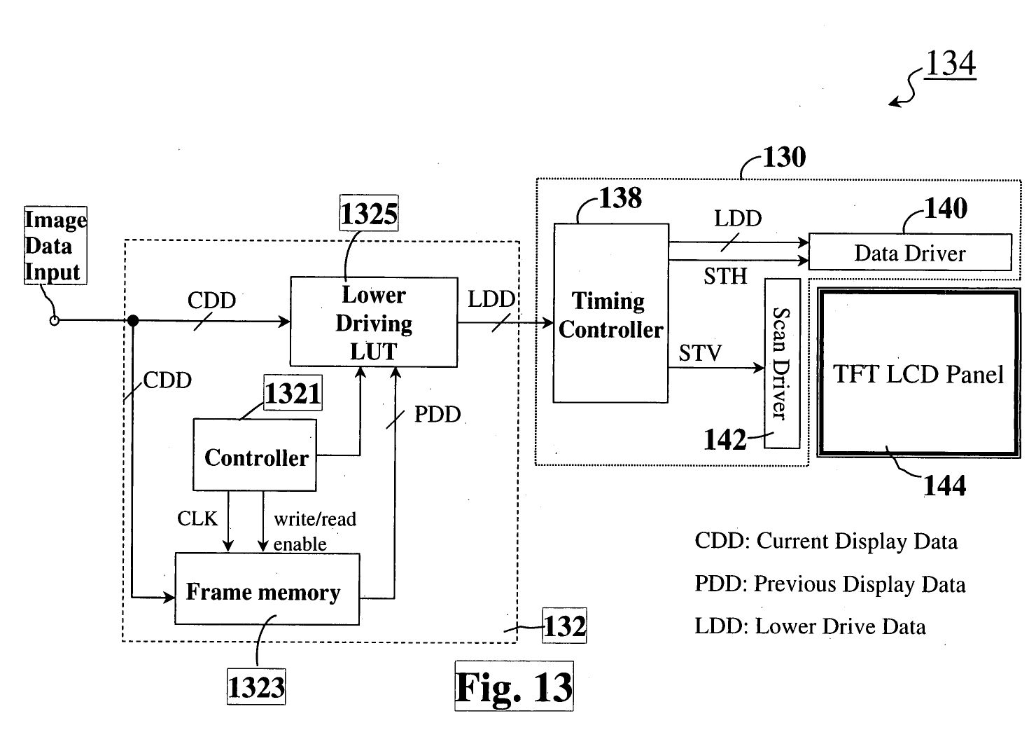

FIG. 9 is a graph depicting driving voltages as a function of time for an over-driving technique according to a different implementation. The over-driving technique of this example is adapted to the situation in which the target voltage v_{g3} of a pixel is larger than the reversed voltage V_{reversed}. First, at a time tₘ, the driving voltage is increased to an intermediate voltage vₘ, which is between the target voltage v_{g3} and the reversed voltage V_{reversed}. Next, at a time t_{god}, the driving voltage is increased from the intermediate voltage vₘ to the over-driving voltage v_{od}, which is larger than the target voltage v_{g3}. Then, at a time t_{g3}, the driving voltage is reduced from the over-driving voltage v_{od} to the target voltage v_{g3}. The driving technique according to the implementation of FIG. 9 (“combined driving technique”) combines the multi-step driving technique with the over-driving technique to maintain normal switching and faster response time of liquid crystal molecules.

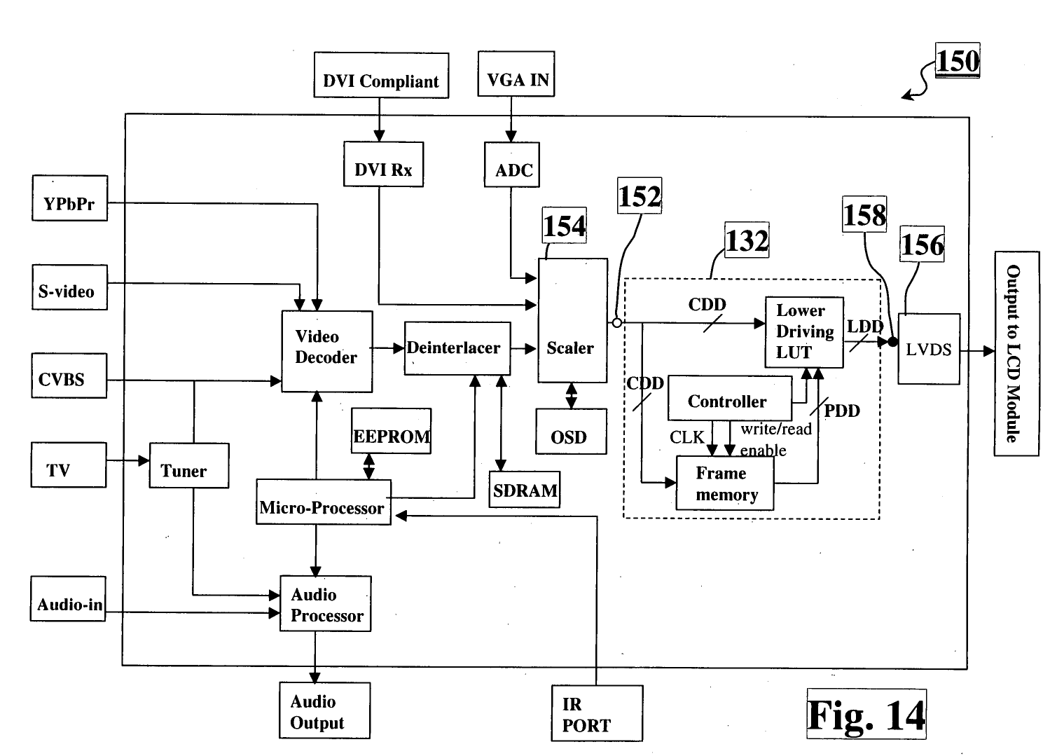

FIG. 10 is a flow chart of a process of selectively performing the over-driving technique (FIG. 8) and the multi-step driving technique (FIG. 4A), according to an embodiment. Frame data of a previous frame is stored (801) by the data compensation device 132 (FIG. 1). For example, the frame data is stored into a frame memory in the data compensation device 132. Next, image data of the previous frame is acquired from the frame memory, and an initial gray scale Gᵢₙᵢₜᵢₐₗ is obtained (802). Image data of a current frame is also received by the data compensation device 132 to obtain a target gray scale G_{taget} (804). The target gray scale G_{target} is compared (806) with the initial gray scale Gᵢₙᵢₜᵢₐₗ by the data compensation device 132. If |G_{target}−Gᵢₙᵢₜᵢₐₗ|>ΔGₗᵢₘᵢₜ, the multi-step driving technique is selected (808). On the other hand, if |G_{taget}−Gᵢₙᵢₜᵢₐₗ|<ΔGₗᵢₘᵢₜ, the over-driving technique is selected (810). Note that, the initial gray scale Gᵢₙᵢₜᵢₐₗ and the target gray scale G_{target} described herein correspond to the initial voltage v_{g1} and the target voltage v_{g3} in FIG. 4A, and ΔGₗᵢₘᵢₜ represents a predefined gray scale difference that corresponds to the reversed bias voltage V_{cg1}. For example, as shown by the curve 402 in FIG. 5, the predefined gray scale different ΔGₗᵢₘᵢₜ is the 244 gray scale.

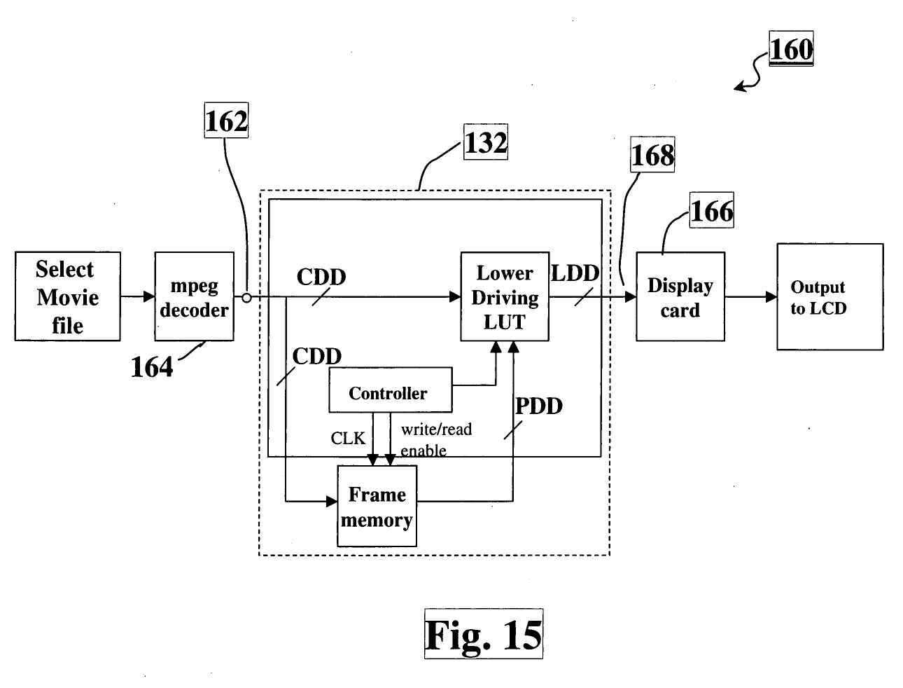

FIG. 11 shows correlations between gray scales and corresponding response time according to a conventional driving technique (curve 902), the multi-step driving technique (curve 904), the over-driving technique (curve 906), and the combined driving technique (curve 908). The abscissa of the graph of FIG. 11 represents gray scale differences, while the ordinate represents response times. As shown by the curve 906, when the over-driving technique is used alone, the response time of the liquid crystal display for low gray scale differences can be shortened efficiently. But when gray scale differences are relatively large, liquid crystal molecules will still rotate in wrong directions and the response time is longer if over-driving is used-alone. As shown by curve 908, the combined driving technique provides superior response time performance. As noted above, the combined driving technique employs the over-driving technique for low gray scale differences but employs the multi-step driving technique for high gray scale differences. As a result, the response speed of the liquid crystal display displaying across the gray scale range is enhanced.

FIG. 12 shows a block diagram of the data compensation device 132 according to some embodiments. The data compensation device 132 includes a controller 1321, a store unit 1323 (e.g., frame memory), and a lower driving look-up table (LUT) 1325.

The data compensation device 132 receives first image data PDD in a first time period and stores it into the store unit 1323, receives second image data CDD in a second time period, where the second time period is delayed from the first time by at least a frame time period. The second image data CDD is stored in the store unit 1323 in the second time period. The lower driving look-up table 1325, under control of the controller 1321, determines a difference between a target gray scale corresponding to the second image data CDD and an initial gray scale corresponding to the first image data PDD (task 806 of FIG. 10). If the lower driving look-up table 1325 determines that the gray scale difference is larger than a predefined gray scale difference ΔGₗᵢₘᵢₜ (which would indicate a voltage step larger than a reversed bias voltage for the pixel), the lower driving look-up table 1325 outputs compensation data LDD associated with an intermediate gray scale that differs from the initial gray scale by less than the predetermined gray scale difference. Note that the compensation data LDD causes the applied voltage to be driven to the intermediate voltage discussed above for the multi-step driving technique according to some embodiments.

In other conditions (such as when the target gray scale associated with the second image data differs from the initial gray scale associated with the first image data by less than the predefined gray scale difference ΔGₗᵢₘᵢₜ), different compensation data LDD can be provided to achieve the over-driving technique. In the over-driving context, the compensation data LDD will cause a voltage driven to a pixel to reach V_{od} (FIG. 8 or 9).

In some implementations, plural driving look-up tables can be employed (instead of one driving look-up table). The different driving look-up tables output different data for different scenarios, such as for the two scenarios discussed above: (1) initial gray scale differs from target gray scale by less than ΔGₗᵢₘᵢₜ; and (2) initial gray scale differs from target gray scale by greater than ΔGₗᵢₘᵢₜ.

The controller 1321 outputs a CLK (clock) signal and write/read enable control signal to control input and output operations of the store unit 1323. The store unit 1323 is used to store pixel gray scale values of a whole frame. The lower driving look-up table 1325, coupled to the store unit 1323, receives the second image data CDD from the data compensation device input and the first image data PDD from the store unit 1323. According to the image data PDD and CDD, compensation image data LDD is derived from the lower driving look-up table 1325.

In performing the multi-step driving technique according to an embodiment, the applied voltage is increased in a first step from an initial voltage to an intermediate voltage, followed by a second step from the intermediate voltage to a target voltage. Note that the multiple steps occur within one frame period, according to some embodiments. In one implementation, the multi-step driving technique is controlled by first supplying compensation data LDD (corresponding to the intermediate voltage of a pixel) as output of the data compensation device 132, and then supplying the second image data CDD from the data compensation device 132. The supply of LDD and CDD both occur within one frame period to enable the application of the multiple voltage steps within one frame period in the multi-step driving technique. To accomplish this, the data compensation device 132 operates at double clock rate.

Similarly, in performing the over-driving technique according to an embodiment, LDD and CDD are supplied successively within one frame period (according to some embodiments) such that LDD first causes the pixel signal to be driven to the over-driving voltage V_{od}, followed by CDD causing the pixel signal to be driven to the target voltage.

In a different embodiment, instead of providing both LDD and CDD in one frame period, as discussed above, the data compensation device 132 provides just the compensation data LDD for the current frame in response to detecting that the second image data CDD differs from the first image data PDD by greater than the predefined gray scale difference for any given pixel. For example, if the gray scale level for pixel X in the first image data PDD for frame n−1 is 0, and the gray scale level for pixel X in the second image data CDD for frame n is 255 (255 differs from 0 by greater than the predefined gray scale difference), then the data compensation device 132 provides compensation data LDD in frame n, where LDD defines a gray scale level for pixel X that is less than 255 (e.g., 248). In this different embodiment, the target voltage for pixel X is effectively reduced by providing a lower gray scale level defined by LDD. However, reducing the target gray scale level for pixel X in frame n allows for improved response time performance. More generally, if CDD (as received by the data compensation device 132) in frame n differs from PDD in frame n−1 by greater than the predefined gray scale level for any given pixel, then the data compensation device 132 outputs LDD in frame n to reduce the target gray scale level of the given pixel in frame n. Note that the compensation image data LDD is based on a comparison of the current image data CDD in frame n with previous image data PDD in frame n−1—the data compensation device 132 does not factor in image data in subsequent frames n+1 and so forth for the purpose of computing LDD for frame n. Therefore, the data compensation device 132 does not have to wait for subsequent image data in frame n+1 to output image data in frame n.

If CDD (as received by the data compensation device 132) in frame n differs from PDD in frame n−1 by less than the predefined gray scale level for each pixel, then the data compensation device 132 outputs CDD (instead of LDD) in frame n.

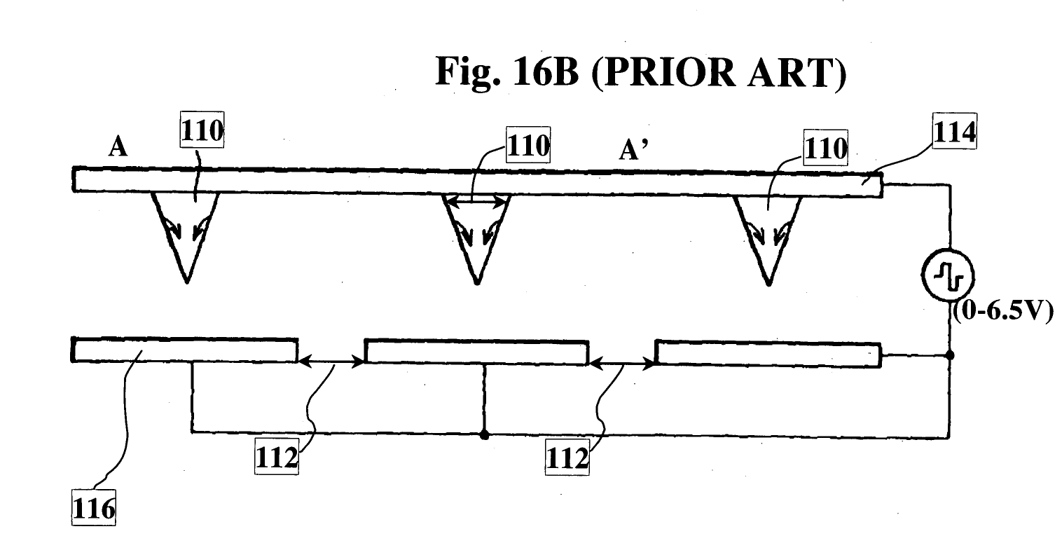

As shown in FIG. 13, the data compensation device 132 and the display driving device 130 are integrated into the liquid crystal display module 134, according to an embodiment. The liquid crystal display module 134 of FIG. 13 at least includes the LCD panel 144 and the display driving device 130, which includes the timing controller 138, the data driver module 140, and the scan driver module 142. The data compensation device 132 is coupled to the timing controller 138 of the display driving device 130, and outputs the compensation image data LDD looked up from the lower driving look-up table 1325 to the timing controller 138. Afterward, the compensation image data LDD is outputted through the timing controller 138 to the data driver module 140. The data driver module 140 converts the compensation image data LDD to corresponding gray scale voltage signals to drive the liquid crystal display panel 144.

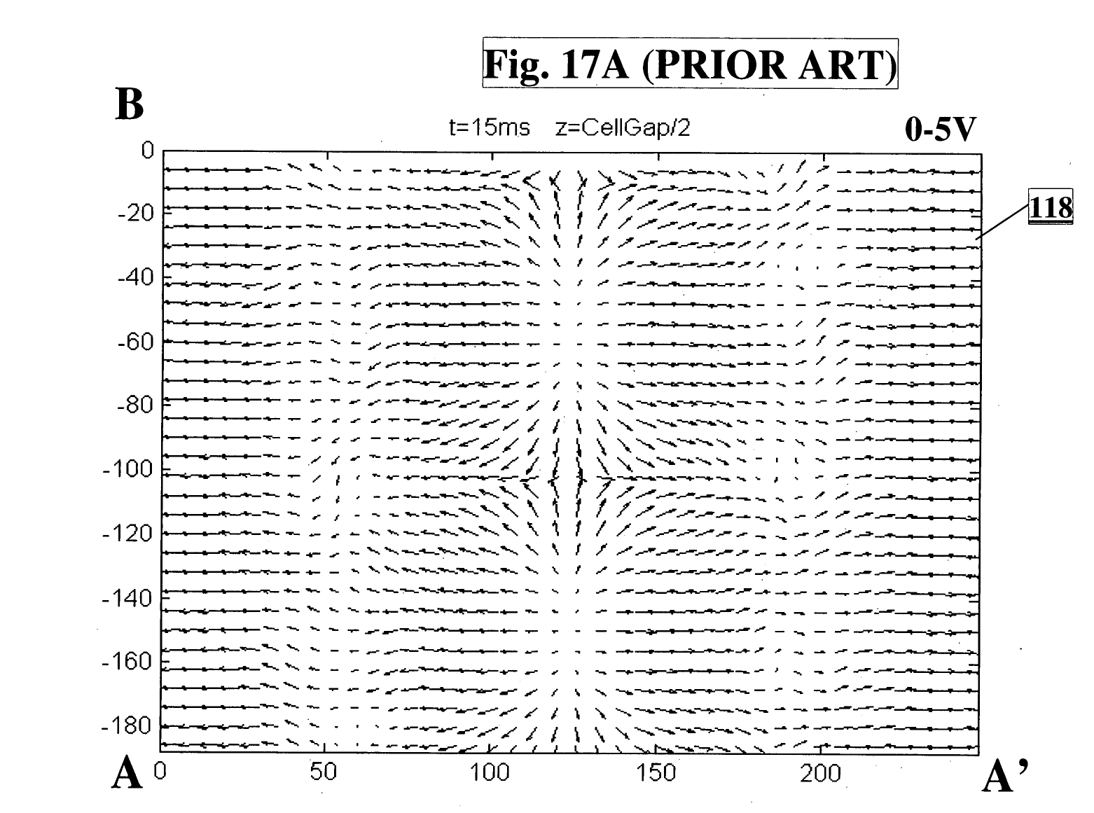

In an alternative embodiment, as shown in FIG. 14, the data compensation device 132 is integrated into a display system circuit board 150, which includes a scaler 154 and an LVDS transmitter 156. In this embodiment, the data compensation device 132 is coupled between an output point 152 of the scaler 154 and an input point 158 of the LVDS transmitter 156. The data compensation device 132 receives the second image data CDD outputted from the scaler 154. According to some embodiments, the data compensation device 132 outputs compensation image data LDD and/or second image data CDD to the LVDS transmitter 156, which drives a liquid crystal display module (e.g., 130 in FIG. 1).

Various other components are also part of the display system circuit board 150, such as a video decoder, a microprocessor, an audio processor, a tuner, an EEPROM, a deinterlacer, an SDRAM, an OSD, a DVI receiver (Rx), and an ADC block.

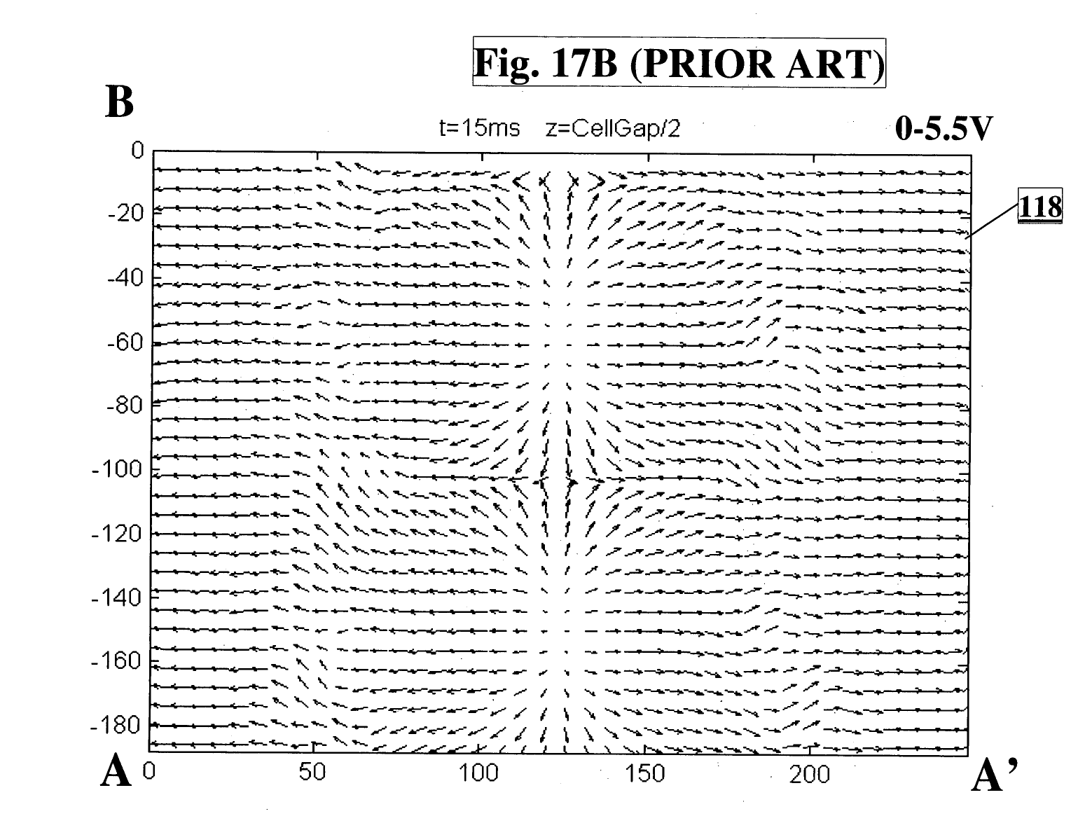

As shown in FIG. 15, according to another embodiment, the data compensation device 132 is implemented in a control device 160, e.g., FPGA (field programmable gate array). The control device 160 includes an MPEG decoder 164 and a display card 166. The data compensation device 132 is coupled between an output point 162 of the MPEG decoder 164 and an input point 168 of the display card 166. The data compensation device 132 receives the second image data CDD outputted from the MPEG decoder 164, outputs the compensation image data LDD to the display card 166, which then drives a liquid crystal display module.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of controlling a pixel signal for a pixel of a display, the pixel signal having an initial voltage during a frame period, the method comprising:
driving the pixel signal from the initial voltage to an intermediate voltage larger than the initial voltage during the frame period;
maintaining the pixel signal at the intermediate voltage for a time interval; and
after the time interval, driving the pixel signal from the intermediate voltage to a target voltage larger than the intermediate voltage during the frame period.

2. The method of claim 1, wherein the pixel is associated with a reversed bias voltage that defines a voltage step that when applied to the pixel will cause abnormal switching of liquid crystal molecules associated with the pixel,
wherein driving the initial voltage to the intermediate voltage results in a voltage step between the initial voltage and the intermediate voltage that is less than the reversed bias voltage.

3. The method of claim 2, wherein driving the pixel signal from the intermediate voltage to the target voltage comprises driving the pixel signal to the target voltage that is greater than the initial voltage by the reversed bias voltage.

4. The method of claim 1, wherein maintaining the pixel signal at the intermediate voltage for the time interval comprises maintaining the pixel signal constant at the intermediate voltage for the time interval.

5. The method of claim 1, further comprising:
receiving current image data for the frame period; and
generating, based on the current image data, compensation image data, wherein the compensation image data causes driving of the pixel signal to the intermediate voltage.

6. The method of claim 5, further comprising receiving previous image data for a previous frame period, wherein generating the compensation image data is based on comparing the current image data with the previous image data.

7. The method of claim 6, wherein the compensation image data is generated in response to a gray scale for the pixel specified by the current image data being greater by a predefined gray scale difference than a gray scale for the pixel specified by the previous image data.

8. The method of claim 1, wherein driving the pixel signal to the intermediate voltage for the time interval before driving the pixel signal to the target voltage reduces likelihood of abnormal switching of liquid crystal molecules associated with the pixel.

9. The method of claim 1, further comprising:
after the time interval from a time point at which the pixel signal was driven to the intermediate voltage, driving the pixel signal from the intermediate voltage to an over-driving voltage greater than the target voltage; and
after a second time interval from a time point at which the pixel signal was driven to the over-driving voltage, driving the pixel signal from the over-driving voltage to the target voltage, wherein the over-driving voltage is greater than the target voltage.

10. The method of claim 1, wherein driving the pixel signal from the initial voltage to the intermediate voltage followed by driving the pixel signal from the intermediate voltage to the target voltage is part of a multi-step driving technique for the pixel, wherein the multi-step driving technique is performed in response to the target voltage being greater than the initial voltage by greater than a predetermined voltage difference.

11. The method of claim 10, further comprising performing an over-driving technique on the pixel in a subsequent frame period in response to detecting that a target voltage of the subsequent frame period is greater than an initial voltage of the subsequent frame period by less than the predetermined voltage difference, wherein performing the over-driving technique comprises:
driving a pixel signal to the pixel in the subsequent frame period from the initial voltage of the subsequent frame period to an over-driving voltage that is greater than the target voltage of the subsequent frame period; and
a time interval later, driving the pixel signal to the pixel in the subsequent frame period from the over-driving voltage to the target voltage.

12. A system comprising:
a display panel having an array of pixels; and
a compensation device to:
receive image data in a first frame period;
compare the received image data to a previous image data;
determine whether a difference between the received image data and previous image data for any given pixel of the array of pixels exceeds a predetermined threshold;
in response to determining that the difference for the given pixel exceeds the predetermined threshold, provide compensation image data in the first frame period, the compensation image data in the first frame period to define a reduced difference with the previous image data for the given pixel.

13. The system of claim 12, wherein the compensation device is adapted to output both the compensation image data and received image data in the first frame period to cause performance of multi-step driving of a pixel signal to the given pixel, wherein the multi-step driving includes:
driving the pixel signal from an initial voltage to an intermediate voltage during the first frame period,
maintaining the pixel signal at the intermediate voltage at the intermediate voltage for a time interval, and
after the time interval, driving the pixel signal from the intermediate voltage to a target voltage that is larger than the intermediate voltage during the first frame period.

14. The system of claim 13, wherein the given pixel is associated with a reversed bias voltage, and wherein the target voltage is greater than the initial voltage by more than the reversed bias voltage.

15. The system of claim 14, wherein the given pixel is associated with the reversed bias voltage that defines a voltage step that when applied to the pixel will cause abnormal switching of liquid crystal molecules associated with the pixel.

16. The system of claim 13, further comprising a display module having the compensation device and the display panel, the display module further having a data driver module to drive data lines of the display panel,
wherein performance of the multi-step driving is provided by the data driver module in response to the compensation image data and received image data provided by the compensation device.

17. The system of claim 13, further comprising:
a system circuit board having the compensation device; and
a display module having a data driver module and the display panel, the data driver module to drive data lines of the display panel,
wherein performance of the multi-step driving is provided by the data driver module in response to the compensation image data and received image data provided by the compensation device.

18. The system of claim 13, further comprising:
an MPEG decoder and a display card, wherein the compensation device is provided between an output of the MPEG decoder and an input of the display card; and
a display module having a data driver module and the display panel, the data driver module to drive data lines of the display panel,
wherein performance of the multi-step driving is provided by the data driver module in response to the compensation image data and received image data provided by the compensation device.

19. The system of claim 13, the compensation device to further provide output to cause performance of over-driving of a pixel signal provided to a second pixel in the array of pixels, wherein over-driving the pixel signal comprises:
driving the pixel signal from a first voltage to an over-driving voltage greater than the first voltage, and
driving the pixel signal from the over-driving voltage to a second voltage that is less than the over-driving voltage.

20. An apparatus for use with a display panel having an array of pixels, the apparatus comprising:
a storage device to store first image data received in a previous frame period; and
a module to:
receive second image data received in a current frame period;
determine whether a target gray scale level corresponding to the second image data for a given pixel exceeds an initial gray scale level corresponding to the first image data for the given pixel by greater than a predefined gray scale difference;
in response to determining that the target gray scale level exceeds the initial gray scale level by greater than the predefined gray scale difference, outputting compensation image data in the current frame period, wherein the compensation image data defines a gray scale level for the given pixel that differs from the initial gray scale level by less than the predefined gray scale difference.

21. The apparatus of claim 19, wherein the compensation image data enables the given pixel to be driven to an intermediate gray scale level from the initial gray scale level during the current frame period, to be maintained at the intermediate gray scale level for a time interval, and to be driven from the intermediate gray scale level to the target gray scale level greater than the intermediate gray scale level during the current frame period.

22. The apparatus of claim 21, wherein the module is adapted to further:
determine whether the target gray scale level exceeds the initial gray scale level by less than the predefined gray scale difference;
in response to determining that the target gray scale level exceeds the initial gray scale level by less than the predefined gray scale difference, outputting second compensation image data to enable over-driving,
the second compensation image data to enable the given pixel to be driven to an over-driving gray scale level from the initial gray scale level, to be maintained at the over-driving gray scale level for a time interval, and to be driven from the over-driving gray scale level to the target gray scale level less than the over-driving gray scale level.

23. The apparatus of claim 21, further comprising a data driver module to drive a pixel signal over a data line to the given pixel,
the data driver module responsive to the compensation image data to perform:
driving the pixel signal from an initial voltage to an intermediate voltage,
maintaining the pixel signal constant at the intermediate voltage for a time interval,
after the time interval, driving the pixel signal from the intermediate voltage to a target voltage greater than the intermediate voltage,
wherein the initial voltage corresponds to the initial gray scale level, the intermediate voltage corresponds to the intermediate gray scale level, and the target voltage corresponds to the target gray scale level.

24. A method of controlling a pixel signal for a pixel of a display, the method comprising:
receiving a first pixel signal for frame (n−1);
receiving a second pixel signal for frame (n);
determining if a difference between the first pixel signal and the second pixel signal is larger than a reversed bias voltage; and
applying an intermediate pixel signal during frame (n) in response to determining that the difference between the first pixel signal and the second pixel signal is larger than the reversed bias voltage;
wherein a difference between the first pixel signal and the intermediate pixel signal is not larger than the reversed bias voltage.
